(19) United States
(12) Patent Application Publication
(10) Pub. No.: US 2023/0354780 A1
(43) Pub. Date: Nov. 9, 2023

(54) COMPANION ANIMAL CUSTOMIZED FEED ORDER SYSTEM

(71) Applicant: NUIT Inc., Seoul (KR)

(72) Inventors: Ji Hwan SEO, Incheon-si (KR); Eun Kyung JEONG, Incheon-si (KR)

(21) Appl. No.: 17/780,721

(22) PCT Filed: Nov. 29, 2019
(86) PCT No.: PCT/KR2019/016768

§ 371 Date: May 27, 2022

(30) Foreign Application Priority Data
Nov. 29, 2019 (KR) 10-2019-0157010

(51) Int. Cl. A01K 29/00; G06Q 10/08

(52) U.S. Cl. CPC A01K 29/005; G06Q 10/08

(57) ABSTRACT

Disclosed is a companion animal customized feed order system including: a store system configured to provide a management service for a store cooking natural food; an input/output terminal configured to receive companion animal basic information from a customer; and a management server configured to calculate a customized natural food recipe according to the companion animal information and transmit the calculated customized natural food recipe to the store system.

### TECHNICAL FIELD

The present invention relates to a companion animal customized feed order system, and more particularly, to a companion animal customized feed order system that may input companion animal basic information to a deep learning model to calculate a natural recipe suitable for veterinary nutrition, provide the natural recipe to a store to make cooking, and receive cooked natural food with any one option of regular delivery/distribution, scheduled delivery/distribution, scheduled pickup, and immediate pickup.

### BACKGROUND ART

Until now, it is known that most of the food for companion animals such as dogs and cats is pellet type dry food, and some food is canned wet food.

An example of a technology related to canned wet feed includes a method for preparing a mixture for pet feed (Korean Patent Laid-Open Publication No. 10-2004-0028810) that includes preparing a mixed paste by further adding soybean oligosaccharide to shreds that are crushed to 10 mesh or less by mixing dregs which are by-products generated at a tofu factory with Neverita didyma sludge generated at a Neverita didyma processing company, obtaining crushed meat by crushing meat and bones including by-products by removing hair and dirt from meat such as chicken, cow, pig, lamb, and turkey and skinning the meat, preparing meat paste that is crushed to 10 mesh or less with a crusher together with liquid by mixing the meat shreds with drinking water and heating the mixture in a hot press at 130° C. for 5 hours, and then mixing the two types of pastes in a 1:1 ratio, stirring the mixture for a certain time, and then additionally mixing inert dry yeast, vitamins, and wood vinegar to the stirred mixture.

In addition, Korean Patent Laid-Open Publication No. 10-2005-0011588 discloses a method of preparing a diet food for pets that includes preparing beef paste by dehydrating and sterilizing soybean meal, finely crushing chicken, and then making the crushed chicken into a chicken paste state by high-temperature, high-pressure, adding 100 to 200 g of mulberry root to a mixture in which 100 to 400 g of beef and bone is mixed with 1,000 to 2,000 M of drinking water, and crushing the mixture by pressing at 120° C. for 1-2 hours; obtaining a feed mixture by mixing and stirring the sterilized soybean meal, chicken paste, and beef paste together in the above step and cooking the mixture at 20° C. for 12 hours; adding and mixing 0.5 to 1 wt % of the feed mixture paste powder prepared in the above step, 0.5 to 2 wt % of seaweed powder, 0.5 to 5 wt % of mulberry leaf powder, 0.55 wt % of vitamins, etc.

All of these wet feeds, dry feeds, and the like are processed feeds in which materials are subjected to high-temperature heat treatment. As dogs and cats begin to feed the processed feed subjected to the heat treatment, many diseases that could not be treated with modern medicine, such as various skin diseases, atopy, and autoimmune diseases that were not discovered before, are occurring and increasing.

Therefore, there is an urgent need to make efforts to feed companion animals such as dogs and cats with natural food or cooked food instead of feed.

### DISCLOSURE

### Technical Problem

One aspect of the present invention provides a companion animal customized feed order system that inputs companion animal basic information suitable for each condition of the companion animals to a deep learning model, calculates a natural recipe suitable for veterinary nutrition, and provides a natural recipe to a store.

Another aspect of the present invention provides a companion animal customized feed order system that builds a platform for receiving natural food orders online or offline, provides options of regular delivery/distribution and scheduled pickup upon receiving natural food, and provides an option of immediate pickup in addition to regular delivery/distribution and scheduled pickup in the case of offline ordering.

Another aspect of the present invention provides a companion animal customized feed order system in that immediately performs delivery/distribution in a store by setting a delivery/distribution boundary for each store in regular delivery/distribution.

Another aspect of the present invention provides a companion animal customized feed order system that includes an affiliate management system for monitoring material preparation by acquiring an image of a material storage case.

Another aspect of the present invention provides a companion animal customized feed order system that includes an interface module for evaluating an interface of a screen output through an input/output terminal.

Technical objects of the present invention are not limited to the objects described above. That is, other objects that are not mentioned may be obviously understood by those skilled in the art from the following description.

### Technical Solution

In one general aspect, a companion animal customized feed order system includes: a store system configured to provide a management service for a store cooking natural food; an input/output terminal configured to receive companion animal basic information from a customer; and a management server configured to calculate a customized natural food recipe according to the companion animal information and transmit the calculated customized natural food recipe to the store system.

The management server may include: a companion animal information receiving unit configured to output a companion animal basic information input request screen for receiving the companion animal basic information including species, a date of birth, weight, a gender, a neutering status, a body shape, an exercise amount, an allergy-inducing material and a special attention option through the input/output terminal to acquire the companion animal basic information; a recipe calculation unit configured to pre-store a plurality of natural food menu recipes according to main materials classified according to a protein source, extract at least one natural food menu according to the companion animal basic information among the plurality of natural food menus, calculate a primary recipe in which the number of grams of each material in the extracted natural food menu is calculated, sequentially output any one of natural food menu selection screen, an additional topping material selection screen, grain material selection screen, and an excluded material selection screen among the at least one extracted natural food menu through the input/output terminal, extract the primary recipe for the natural food menu selected from the natural food menu selection screen from the primary recipe for the extracted natural food menu, and calculate final natural food menu recipe from the primary recipe for the natural food menu selected from the natural food menu selection screen by reflecting the material selected from the additional topping material selection screen, the grain material selection screen, and the excluded material selection screen; and a reception option setting unit configured to output a reception option selection screen for receiving a selection of a reception option of a cooked natural food menu through the input/output terminal, output the reception option selection screen including options of regular delivery/distribution, scheduled delivery/distribution, scheduled pickup, and immediate pickup when the input/output terminal is a terminal installed in a store, output the reception option selection screen including the options of the regular delivery/distribution, the scheduled delivery/distribution, and the scheduled pickup is output when the input/output terminal is a customer personal terminal, and transmit the final natural food menu recipe to the store system according to the reception option input through the reception option selection screen, the pre-storing, by the recipe calculation unit, the plurality of natural food menu recipes according to the main materials classified according to the protein source may be pre-storing the plurality of natural food menu recipes including each material in 0.1 g/l kcal unit for each of the plurality of natural food menus, the extracting, by the recipe calculation unit, the at least one natural food menu according to the companion animal basic information from among the plurality of natural food menus may be building a deep learning model that trains natural food menus and their calories and nutrient ingredient ratios for each species, date of birth, weight, gender, neutering status, body shape, exercise amount, allergy-inducing material, and special attention option and extracting at least one natural food menu suitable for the companion animal basic information among the plurality of natural food menus and their calories and nutrient ingredient ratios by inputting the received companion animal basic information to the deep learning model through the input/output terminal, the calculating, by the recipe calculation unit, the primary recipe in which the number of grams of each material in the extracted natural food menu is calculated may be calculating the primary recipe by multiplying the at least one extracted natural food menu and the calories thereof by 0.1 g/l kcal unit of each material of each of the pre-stored natural food menu recipes, the calculating, by the recipe calculation unit, the final natural food menu recipe from the primary recipe for the natural food menu selected from the natural food menu selection screen may be pre-storing the number of grams of each additional topping material and grain material for each calorie of the plurality of natural food menus, adding the material input from the additional topping material selection screen and the grain material selection screen to the primary recipe, and calculating the final natural food menu recipe by excluding the material input from the excluded material selection screen, and the transmitting, by the reception option setting unit, the final natural food menu recipe to the store system according to the reception option input through the reception option selection screen may be pre-storing delivery/distribution possible areas for each store, outputting and receiving a screen requesting a customer's address and a delivery/distribution time through the input/output terminal and checking whether a store including the customer's address as the delivery/distribution possible area is located, when the regular delivery/distribution or the scheduled delivery/distribution option is selected through the reception option selection screen, outputting a message informing that the delivery/distribution is impossible through the input/output terminal when there is no store that includes the customer's address as the delivery/distribution possible area, calculating the final natural food menu recipe calculated by the recipe calculation unit and a cooking start time corresponding to the delivery/distribution request time is calculated and transmitting the calculated final natural food menu recipe and cooking start time to the stores system of the store when there is the store including the customer's address as the delivery/distribution possible area, outputting and receiving a screen requesting a pickup store and a pickup time is outputted through the input/output terminal and received, and calculating the final natural food menu recipe calculated by recipe calculation unit and the cooking start time corresponding to the pickup time and transmitting the calculated final natural food menu recipe and cooking starting time to the store system of the pickup store when the option of the scheduled pickup is selected through the reception option selection screen, and transmitting the final natural food menu recipe calculated by the recipe calculation unit to the store system of the store equipped with the input/output terminal when the option of the immediate pickup is selected through the reception option selection screen, the store system may include an affiliate management system that includes a material storage case configured to store a plurality of materials required for cooking in the plurality of natural food menu recipes; a camera configured to acquire an image of the material storage case by photographing the material storage case at predetermined time intervals; and a computing unit configured to compare images continuously acquired through the camera and monitor whether the material stored in the material storage case is prepared, and the input/output terminal may include an interface evaluation module that includes a screenshot generation unit configured to acquire a plurality of screenshot images of the input/output terminal according to a predetermined period; and an interface evaluation module configured to compare continuous screenshot images to group the plurality of screenshot images for each output through the input/output terminal, calculate the number of screenshot images included in each group to list each group in the order of the largest number of screenshot images, and compare reference images for each screen output through the input/output terminal and the screenshot images included in each group to extract the screens corresponding to each group.

### Advantageous Effects

According to an aspect of the present invention, it is possible to calculate a companion animal customized natural food recipe based on a deep learning model, and provides it to a store to facilitate natural food cooking.

According to another aspect of the present invention, it is possible to improve user convenience by building an on-offline ordering system.

According to another aspect of the present invention, it is possible to deliver/distribute fresh natural food to customers by building an immediate pickup or boundary delivery/distribution system.

According to another aspect of the present invention, it is possible to ensure freshness of cooked natural food, including an affiliate management system, it is easy to manage franchisees remotely, and it is possible to cultivate good materials management habits of franchisees.

According to another aspect of the present invention, it is possible to improve user convenience by improving an interface reflecting a user's actual usage pattern, including an interface evaluation module.

### BRIEF DESCRIPTION OF THE DRAWINGS

FIG. 1 is a conceptual diagram of a companion animal customized feed order system according to an embodiment of the present invention.

FIG. 2 is an example of an input/output terminal illustrated in FIG. 1.

FIG. 3 is a control block diagram of a management server illustrated in FIG. 1.

FIGS. 4 to 6 are examples of screens output to the input/output terminal illustrated in FIG. 1.

FIG. 7 is a conceptual diagram of an affiliate management system according to an embodiment of the present invention.

FIG. 8 is a conceptual diagram of an interface evaluation module according to an embodiment of the present invention.

### DESCRIPTION OF REFERENCE SIGNS

1: Companion animal customized feed order system
100: Input/output terminal
300: Management server
500: Store system

### BEST MODE

Exemplary embodiments of the present invention will be described in detail with reference to the accompanying drawings. These embodiments will be described in detail for those skilled in the art in order to practice the present invention. It should be appreciated that various exemplary embodiments of the present invention are different from each other, but do not have to be exclusive. For example, specific shapes, structures, and characteristics described herein may be implemented in another embodiment without departing from the spirit and the scope of the present invention in connection with an embodiment. In addition, it should be understood that a position or an arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. Similar reference numerals will be used to describe the same or similar functions throughout the accompanying drawings.

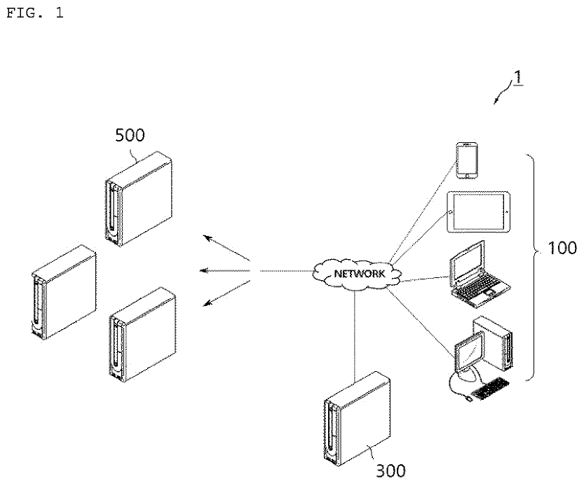

FIG. 1 is a conceptual diagram of a companion animal customized feed order system according to an embodiment of the present invention.

Referring to FIG. 1, a companion animal customized feed order system 1 according to an embodiment of the present invention may include a store system 500, an input/output terminal 100, and a management server 300.

The companion animal customized feed order system 1 according to an embodiment of the present invention designs a veterinary nutrition customized natural food recipe according to companion animal information input through the input/output terminal 100 and transmits the designed veterinary nutrition customized natural food recipe to the store system 500, thereby performing natural cooking according to the recipe.

The companion animal customized feed order system 1 according to the embodiment of the present invention builds a platform for receiving natural food orders online or offline. Here, for online orders, an option of regular delivery/distribution, scheduled delivery/distribution, and scheduled pickup for natural food receipt is provided, and for offline orders, an option of the immediate pickup in addition to the regular delivery/distribution, the scheduled delivery/distribution, and the scheduled pickup is provided.

In particular, the companion animal customized feed order system 1 according to the embodiment of the present invention provides the option of the immediate pickup when ordering offline, with the aim of providing freshly cooked natural food without freezing, and in the regular delivery/distribution, sets delivery/distribution boundaries for each store so that the delivery/distribution is immediately made at the store.

In addition, the companion animal customized feed order system 1 according to the embodiment of the present invention may perform the delivery/distribution in an online store, build the delivery/distribution boundary through the extension of the manufacturing line, and perform the delivery/distribution at a nearby manufacturing line or store within a delivery/distribution boundary.

Hereinafter, each component of the companion animal customized feed order system 1 according to an embodiment of the present invention illustrated in FIG. 1 will be described in detail.

The store system 500 may be a typical store management system that is installed in each store and hosts a store management program through a network to provide a store management service.

For example, the store system 500 may include a POS terminal that transmits product sales, orders, order details, etc., of a customer, and a store server that receives and processes information from the POS terminal. In particular, in the present embodiment, the store server may receive a natural order history through the management server 300 by communicating with the management server 300 to be described later, and may output the natural order history to the POS terminal or a separate store management terminal (e.g., a terminal provided in a kitchen) so that the natural food manufacturing or delivery/distribution is made according to the natural food order details. Here, the natural food order history may include companion animal information, recipes, delivery/distribution/pickup schedules, and the like.

The input/output terminal 100 may execute a natural food ordering platform provided by the management server 300 to receive companion animal information from a customer and proceed with a companion animal customized natural food ordering procedure. For example, the input/output terminal 100 may execute a natural ordering platform through an application installed in the terminal, or may execute a natural ordering platform by accessing a website built by the management server 300.

The input/output terminal 100 is a broad concept meaning various types of information communication devices and multimedia devices supporting wired and wireless networks such as mobile communication terminals widely used by the general public, such as a notebook, a smart phone, and a tablet PC, in addition to a desktop computer (PC).

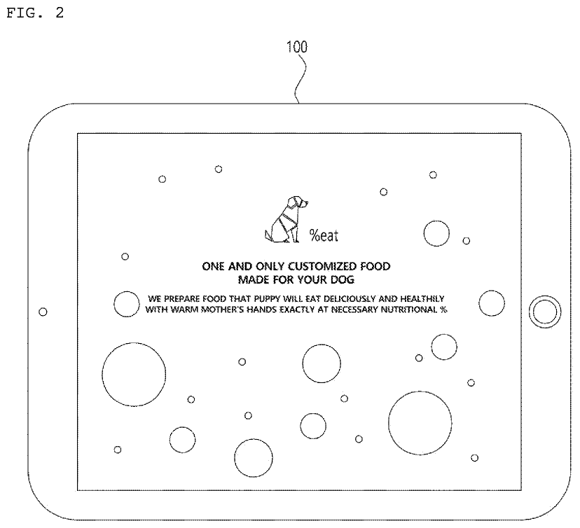

FIG. 2 is an example of the input/output terminal illustrated in FIG. 1.

Referring to FIG. 2, the input/output terminal 100 may be configured as a tablet computer, and may execute a natural ordering platform through an application installed in the terminal.

The input/output terminal 100 may be provided in a store to implement an offline ordering service, and in this case, may be provided in the form of a kiosk directly interlocked with the store system 500.

The management server 300 is a server of a general type that processes and provides predetermined information in response to a client's access request, and may implement a natural ordering platform according to an embodiment of the present invention.

For example, the management server 300 may request and receive companion animal information through the input/output terminal 100, and calculate a customized recipe optimized for the companion animal information. In this case, the recipe may include the number of grams and calories of materials to be cooked in units of 0.1 g/l kcal.

The management server 300 may transmit the calculated recipe to the store system 500, and the store system 500 may output the recipe so that cooking may proceed according to the calculated recipe.

Here, the management server 300 may select a natural food receiving method through the input/output terminal 100 as any one of the regular delivery/distribution, the scheduled delivery/distribution/pickup, and the immediate pickup, and may calculate the cooking time according to the reception method and transmit the calculated cooking time to the store system 500 together with the recipe.

In this case, the management server 300 may limit the natural reception option. The management server 300 may set and manage delivery/distribution boundaries for each store, and build a base-based delivery/distribution system by adding a delivery/distribution option to the natural reception option according to whether there is a delivery/distribution boundary corresponding to the customer address.

A detailed description of the implementation of the natural ordering platform in the management server 300 will be described later.

The companion animal customized feed order system 1 according to the embodiment of the present invention may build an easy and quick natural cooking system by calculating and providing a customized recipe optimized for companion animal information in units of grams of each material. This may lead to fresh finished product supply and, in particular, may achieve immediate pickup service.

In addition, the companion animal customized feed order system 1 according to the embodiment of the present invention builds the base-based delivery/distribution system to implement fresh delivery/distribution of finished products, and furthermore, simplifies distribution steps to realize the effect of maintaining quality and reducing cost.

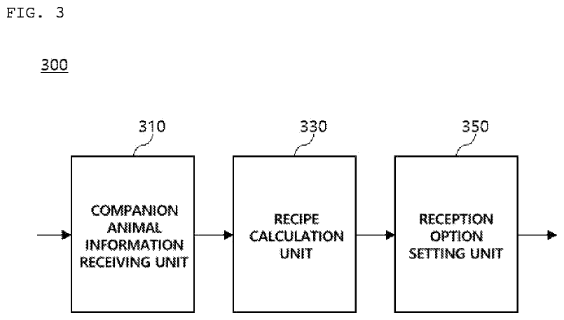

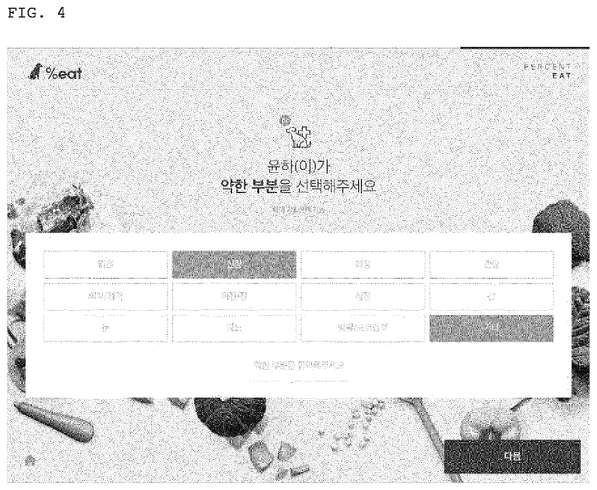

FIG. 3 is a control block diagram of the management server illustrated in FIG. 1, and FIGS. 4 to 6 are examples of screens output to the input/output terminal illustrated in FIG. 1.

Referring to FIG. 3, the management server 300 may include a companion animal information receiving unit 310, a recipe calculation unit 330, and a reception option setting unit 350.

The companion animal information receiving unit 310 may output a companion animal basic information input request screen through the input/output terminal 100.

The companion animal basic information may include species, a date of birth, a weight, a gender, a neutering status, a body shape, an exercise amount, an allergy-inducing material, and a special attention option.

Referring to FIG. 4, the special attention option may include kidney, pancreas, joint, skin/mucous membrane, stomach/intestine, heart, liver, eyes, diabetes, bladder/urolithiasis, and other options as parts where pets are weak.

The recipe calculation unit 330 may pre-store recipes for each natural food menu. In this embodiment, the natural food menu may be divided into chicken, pork, duck, beef, salmon, cod, and other main material menus based on main materials classified according to the protein source, and each natural food menu recipe is veterinarily designed by experts in 0.1 g/l kcal of each material.

The recipe calculation unit 330 may build a deep learning model that trains appropriate calories and nutrient secretion rates of the natural food menus for each companion animal basic information. For example, the nutrient secretion rate means a rate of protein, carbohydrate, lipid, moisture, phosphorus, potassium, calcium, etc., in the natural food menu. The recipe calculation unit 330 may adopt a deep belief network (DBN) model as the deep learning model.

The recipe calculation unit 330 may build the deep learning model that trains the natural food menu and the calorie and nutritional component ratio thereof for each species, date of birth, weight, gender, neutering status, body shape, exercise amount, allergy-inducing material, and special attention option included in the companion animal basic information. When inputting the companion animal basic information acquired from the companion animal information receiving unit 310 to the deep learning model, the recipe calculation unit 330 may extract at least one natural food menu optimized for the companion animal basic information and its calorie and nutrient ingredient ratio.

The recipe calculation unit 330 may calculate the number of grams of each material of the extracted natural food menu by multiplying the extracted natural food menu and its calories and nutrient secretion rate by 0.1 g/l kcal unit of each material of each pre-stored natural food menu recipe, thereby calculating a primary recipe. For example, the primary recipe may be calculated as “Chicken menu: chicken 22 g, broccoli 3 g, carrot 3.7 g, kale 1.5 g, steamed.”

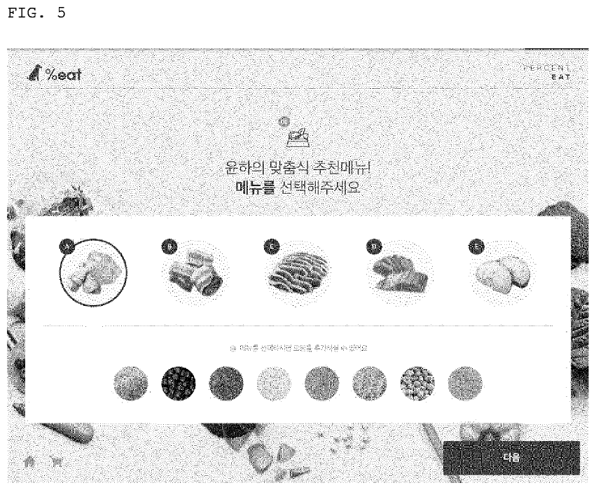

Referring to FIG. 5, the recipe calculation unit 330 may output a natural food menu selection screen through the input/output terminal 100. Here, the natural food menu selection screen is a selection screen for the natural food menu extracted by the recipe calculation unit 330 according to the companion animal basic information.

Also, the recipe calculation unit 330 may output an additional topping material selection screen through the input/output terminal 100. Additional topping materials may be divided into anchovy powder (calcium), eggshell powder (calcium), egg yolk (antioxidant), sesame salt (brain and blood vessel health), natto (anticancer activity), flaxseed powder (skin health), and other additional topping materials. The grain menu may be divided into white rice, oat grains, sweet potatoes, and pasta.

In addition, the recipe calculation unit 330 may output a grain material selection screen through the input/output terminal 100. The grain material may be divided into white rice, oat grains, sweet potato, pasta, and other grain materials.

In addition, the recipe calculation unit 330 may output an excluded material description screen through the input/output terminal 100.

The recipe calculation unit 330 may extract the primary recipe of the menu corresponding to the natural food menu selection through the input/output terminal 100. The recipe calculation unit 330 may add the additional topping material and grain material selected through the input/output terminal 100 to the primary recipe, and exclude the excluded material, thereby calculating the final recipe. Here, the recipe calculation unit 330 may store the number of grams of each additional topping material and grain material for each calorie of the natural food menu.

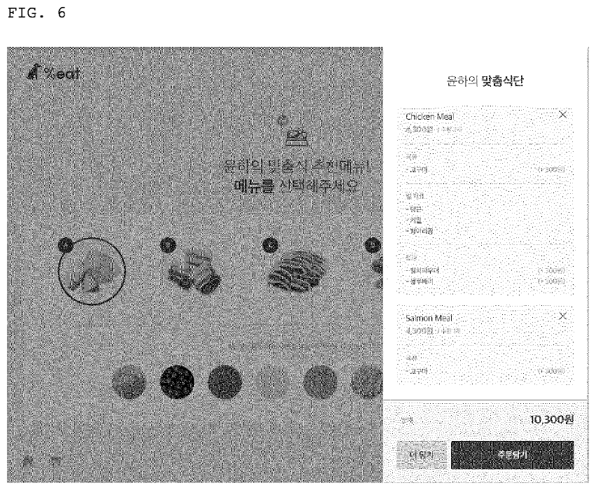

Referring to FIG. 6, the recipe calculation unit 330 may calculate payment information according to the calculated recipe, and may proceed with payment by interlocking with an external payment server, and when the payment is completed, may provide an order table to the input/output terminal 100.

The reception option setting unit 350 may output a reception option selection screen for receiving a selection of a reception option of a cooked menu through the input/output terminal 100.

The reception option setting unit 350 may output a reception option selection screen including options of regular delivery/distribution, scheduled delivery/distribution, scheduled pickup, and immediate pickup when the input/output terminal 100 is a terminal provided in a store.

When the input/output terminal 100 is a customer personal terminal, the reception option setting unit 350 may output a reception option selection screen including the options of the regular delivery/distribution, the scheduled delivery/distribution, and the scheduled pickup.

When the regular delivery/distribution and scheduled delivery/distribution options are selected through the input/output terminal 100, the reception option setting unit 350 may output a screen requesting the customer's address and delivery/distribution time through the input/output terminal 100.

The reception option setting unit 350 may pre-store delivery/distribution possible areas for each store. As described above, since delivery/distribution is made directly to an address of a product cooked directly in the store, an area within a predetermined distance from a store may be set as a delivery/distribution possible boundary. The reception option setting unit 350 may check whether a store including the customer's address input through the input/output terminal 100 as a delivery/distribution possible area is located.

When there is no store including the customer's address input through the input/output terminal 100 as the delivery/distribution possible area, the reception option setting unit 350 may output a message informing that the delivery/distribution is impossible through the input/output terminal 100.

When the store including the customer's address input through the input/output terminal 100 as the delivery/distribution possible area is located, the reception option setting unit 350 may transmit the recipe calculated by the recipe calculation unit 330 to the store system 500 of the corresponding store. In this case, the reception option setting unit 350 may calculate the cooking start time according to the delivery/distribution time set by the customer and transmit the cooking start time together to the store system 500. The store system 500 may output the recipe received from the recipe calculation unit 330 so that the recipe may be checked in a kitchen, and proceed with cooking according to the recipe. Here, the number of grams of materials for each natural food menu may be listed in the recipe, and therefore, in the kitchen, cooking will be done in about 5 to 15 minutes on average.

The reception option setting unit 350 may output a screen requesting a pickup store and a pickup time through the input/output terminal 100 when the option of the scheduled pickup is selected through the input/output terminal 100. The reception option setting unit 350 may transmit the recipe calculated by the recipe calculation unit 330 to the store system 500 of the corresponding store, and may calculate the cooking start time and transmit the calculated cooking start time to the store system 500 together as described above.

When the reception option setting unit 350 receives an option of immediate pickup through the input/output terminal 100, the reception option setting unit 350 may transmit the recipe calculated by the recipe calculation unit 330 to the store system 500 of the store equipped with the input/output terminal 100.

Meanwhile, the companion animal customized feed order system 1 according to the embodiment of the present invention may further include an affiliate management system.

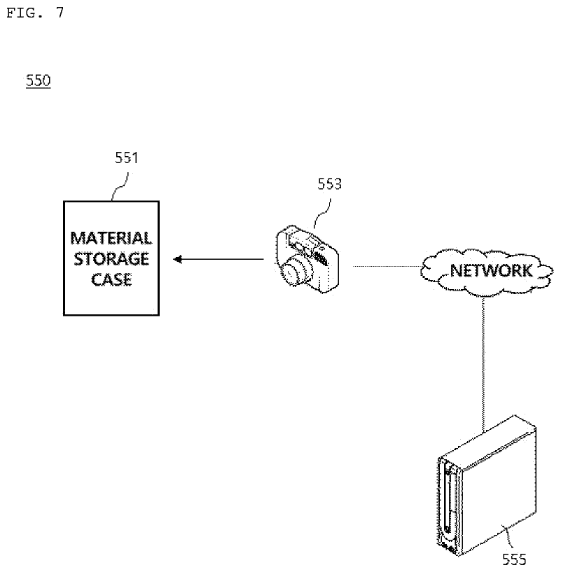

The affiliate management system may be included as one configuration of the store system 500 illustrated in FIG. 1, and may monitor the operating state of each store by determining whether the material required for the companion animal customized natural cooking according to the present embodiment is prepared in the store. This will be described in detail with reference to FIG. 7.

FIG. 7 is a conceptual diagram of an affiliate management system according to an embodiment of the present invention.

Referring to FIG. 7, the affiliate management system 550 may include a material storage case 551, a camera 553, and a calculation unit 555.

The material storage case 551 is a case for storing materials necessary for customized natural food cooking for companion dogs according to the present embodiment. For example, the material storage case 551 may be configured as a case in which compartments are classified according to main materials, sub-materials, additional toppings, and grain types.

The camera 553 is a device for photographing the material storage case 551, and may be a general camera or a camera built into the terminal.

The camera 553 may acquire an image of the material storage case 551 at a predetermined time interval (e.g., 1 day).

The calculation unit 555 may predict whether materials stored in the material storage case 551 are prepared by comparing images continuously acquired through the camera 553. The companion animal customized feed order system 1 according to the present embodiment aims at order delivery/distribution of natural food cooked with fresh materials. Accordingly, each affiliate store may determine a material potion manual in the material storage case 551 when it is opened every day. The calculation unit 555 may monitor the material preparation state every day by comparing the images continuously acquired through the camera 553. For example, the calculation unit 555 may calculate a mismatch rate (%) between two images that are continuously acquired, and when the mismatch rate exceeds a preset reference value, may consider that the material preparation of the store is not properly made and transmit the result to the management server 300.

On the other hand, the material storage case 551 may include a load cell as a pressure sensor on the lower side. In this case, one load cell may be provided in each compartment of the material storage case 551. The load cell may convert a change in resistance value during vertical tension change into weight, and in the present embodiment, the load cell may transmit the converted weight data to the calculation unit 555 through a wireless communication device. That is, when the material stored in each compartment of the material storage case 551 is added or removed, the load cell may generate weight data corresponding to the change amount.

The calculation unit 555 may acquire a recipe received from the management server 300 to the store system 500. Here, the recipe indicates the number of grams of material.

The calculation unit 555 may compare the recipe with the amount of material change in each compartment received from the material storage case 551 to check whether the material is properly prepared in real time. When the amount of material change in each compartment received from the material storage case 551 and the number of grams of material described in the recipe differ by 0.01 g or more, the calculation unit 555 may consider that the cooking has not been performed according to the recipe and transmit the result to the management server 300.

In such a case, the management server 300 may reflect the material preparation state in the affiliation evaluation of the store, facilitate the store management, and provide better services to consumers.

In addition, the companion animal customized feed order system 1 according to the embodiment of the present invention may further include the interface evaluation module.

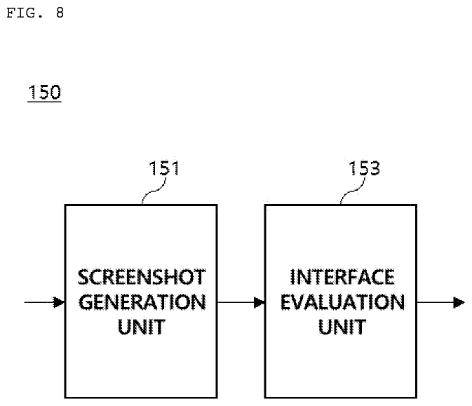

The interface evaluation module may be included as one configuration of the input/output terminal 100 illustrated in FIG. 1, and may evaluate the ease of use of each screen output through the input/output terminal 100. In this regard, it will be described in detail with reference to FIG. 8.

FIG. 8 is a conceptual diagram of an interface evaluation module according to an embodiment of the present invention.

Referring to FIG. 8, the interface evaluation module 150 may include a screenshot generation unit 151 and an interface evaluation unit 153.

The screenshot generation unit 151 may acquire a screenshot image according to a predetermined cycle while the companion animal customized natural food ordering platform according to the present embodiment is executed through the input/output terminal 100.

The screenshot generation unit 151 may acquire a plurality of screenshot images of the input/output terminal 100 during one cycle (from the start of the order to the time of payment completion).

The interface evaluation unit 153 may compare a plurality of screenshot images acquired during one cycle. The interface evaluation unit 153 may check whether there is a change in continuous screenshot images, and group a plurality of screenshot images acquired during one cycle for each screen output through the input/output terminal 100. That is, when there is no change in the continuous screenshot images, the same screen is output through the input/output terminal 100.

The interface evaluation unit 153 may calculate the number of screenshot images included in each group, and list each group in the order of the number of images. The interface evaluation unit 153 may pre-store a reference image for each screen output through the input/output terminal 100, compare the screenshot images of each group, and extract which screen corresponds to each group.

The interface evaluation unit 153 may transmit the group and each screen mapping result to the screen creation manager terminal so that the improvement in the interface for the screen corresponding to the highest group may be considered preferentially.

Such a companion animal customized feed order system may be implemented as an application or implemented in the form of program instructions that may be executed through various computer components and recorded in a computer-readable recording medium. The computer-readable recording medium may include a program command, a data file, a data structure, or the like, alone or a combination thereof.

The program instructions recorded in the computer-readable recording medium may be especially designed and constituted for the present invention or be known to those skilled in the field of computer software.

Examples of the computer-readable recording medium may include a magnetic medium such as a hard disk, a floppy disk, or a magnetic tape; an optical medium such as a compact disk read only memory (CD-ROM) or a digital versatile disk (DVD); a magneto-optical medium such as a floptical disk; and a hardware device especially configured to store and execute program instructions, such as a ROM, a random access memory (RAM), or a flash memory.

Examples of the program instructions include a high-level language code capable of being executed by a computer using an interpreter, or the like, as well as a machine language code created by a compiler. The hardware device may be constituted to be operated as one or more software modules to perform processing according to the present invention, and vice versa.

Although the embodiments of the present invention have been described hereinabove, those skilled in the art will be able to understand that the present invention may be variously modified and altered can be made without departing from the spirit and scope of the present invention disclosed in the following claims.

1. A companion animal customized feed order system, comprising:
a store system configured to provide a management service for a store cooking natural food;
an input/output terminal configured to receive companion animal basic information from a customer; and
a management server configured to calculate a customized natural food recipe according to the companion animal information and transmit the calculated customized natural food recipe to the store system.

2. The companion animal customized feed order system of claim 1, wherein the management server includes:
a companion animal information receiving unit configured to output a companion animal basic information input request screen for receiving the companion animal basic information including species, a date of birth, weight, a gender, a neutering status, a body shape, an exercise amount, an allergy-inducing material and a special attention option through the input/output terminal to acquire the companion animal basic information;
a recipe calculation unit configured to pre-store a plurality of natural food menu recipes according to main materials classified according to a protein source, extract at least one natural food menu according to the companion animal basic information among the plurality of natural food menus, calculate a primary recipe in which the number of grams of each material in the extracted natural food menu is calculated, sequentially output any one of natural food menu selection screen, an additional topping material selection screen, grain material selection screen, and an excluded material selection screen among the at least one extracted natural food menu through the input/output terminal, extract the primary recipe for the natural food menu selected from the natural food menu selection screen from the primary recipe for the extracted natural food menu, and calculate final natural food menu recipe from the primary recipe for the natural food menu selected from the natural food menu selection screen by reflecting the material selected from the additional topping material selection screen, the grain material selection screen, and the excluded material selection screen; and
a reception option setting unit configured to output a reception option selection screen for receiving a selection of a reception option of a cooked natural food menu through the input/output terminal, output the reception option selection screen including options of regular delivery/distribution, scheduled delivery/distribution, scheduled pickup, and immediate pickup when the input/output terminal is a terminal installed in a store, output the reception option selection screen including the options of the regular delivery/distribution, the scheduled delivery/distribution, and the scheduled pickup is output when the input/output terminal is a customer personal terminal, and transmit the final natural food menu recipe to the store system according to the reception option input through the reception option selection screen,
the pre-storing, by the recipe calculation unit, the plurality of natural food menu recipes according to the main materials classified according to the protein source is pre-storing the plurality of natural food menu recipes including each material in 0.1 g/l kcal unit for each of the plurality of natural food menus,
the extracting, by the recipe calculation unit, the at least one natural food menu according to the companion animal basic information from among the plurality of natural food menus is building a deep learning model that trains natural food menus and calories and nutrient ingredient ratios thereof for each species, date of birth, weight, gender, neutering status, body shape, exercise amount, allergy-inducing material, and special attention option and extracting at least one natural food menu suitable for the companion animal basic information among the plurality of natural food menus and their calories and nutrient ingredient ratios by inputting the received companion animal basic information to the deep learning model through the input/output terminal,
the calculating, by the recipe calculation unit, the primary recipe in which the number of grams of each material in the extracted natural food menu is calculated is calculating the primary recipe by multiplying the at least one extracted natural food menu and the calories thereof by 0.1 g/l kcal unit of each material of each of the pre-stored natural food menu recipes,
the calculating, by the recipe calculation unit, the final natural food menu recipe from the primary recipe for the natural food menu selected from the natural food menu selection screen is pre-storing the number of grams of each additional topping material and grain material for each calorie of the plurality of natural food menus, adding the material input from the additional topping material selection screen and the grain material selection screen to the primary recipe, and calculating the final natural food menu recipe by excluding the material input from the excluded material selection screen, and
the transmitting, by the reception option setting unit, the final natural food menu recipe to the store system according to the reception option input through the reception option selection screen is pre-storing delivery/distribution possible areas for each store, outputting and receiving a screen requesting a customer's address and a delivery/distribution time through the input/output terminal and checking whether a store including the customer's address as the delivery/distribution possible area is located, when the regular delivery/distribution or the scheduled delivery/distribution option is selected through the reception option selection screen, outputting a message informing that the delivery/distribution is impossible through the input/output terminal when there is no store that includes the customer's address as the delivery/distribution possible area, calculating the final natural food menu recipe calculated by the recipe calculation unit and a cooking start time corresponding to the delivery/distribution request time is calculated and transmitting the calculated final natural food menu recipe and cooking start time to the stores system of the store when there is the store including the customer's address as the delivery/distribution possible area, outputting and receiving a screen requesting a pickup store and a pickup time is outputted through the input/output terminal and received, and calculating the final natural food menu recipe calculated by recipe calculation unit and the cooking start time corresponding to the pickup time and transmitting the calculated final natural food menu recipe and cooking starting time to the store system of the pickup store when the option of the scheduled pickup is selected through the reception option selection screen, and transmitting the final natural food menu recipe calculated by the recipe calculation unit to the store system of the store equipped with the input/output terminal when the option of the immediate pickup is selected through the reception option selection screen.
